(19) United States
(12) Patent Application Publication
(10) Pub. No.: US 2007/0042128 A1
(43) Pub. Date: Feb. 22, 2007

(54) Ruler and method of manufacture

(75) Inventor: John Waterfield, Leicester (GB)

Correspondence Address: YOUNG & BASILE, P.C., 3001 WEST BIG BEAVER ROAD, SUITE 624, TROY, MI, 48084, US

(73) Assignee: CREATIVE GRIDS UK LTD, LEICESTER (GB)

(21) Appl. No.: 10/553,560

(22) PCT Filed: Apr. 15, 2004
(86) PCT No.: PCT/GB04/01656

§ 371 Date: Oct. 13, 2006

(30) Foreign Application Priority Data
Apr. 15, 2003 (GB) 0308653.5

(51) Int. Cl. B05D 5/00; B05D 1/36; C08F 2/46

(52) U.S. Cl. 427/487; 427/256; 427/402; 33/755

(57) ABSTRACT

A process for the manufacture of a ruler for use in the accurate measuring of fabric for quilting, patchwork and other crafts includes the steps of forming a ruler blank from a single layer of a substantially transparent material, printing, in one or more discrete stages, a pattern onto a surface of the blank, the pattern comprising a single colour or multi-colour pattern corresponding to the scalar markings on the ruler and in a further stage printing a non-slip pattern onto the same surface of the ruler, characterised in that the printing composition used for printing the non-slip pattern comprises an ink which can be dried using ultra violet light; an adhesive and a granular filler, capable of imparting non-slip properties to the surface of the ruler. A ruler produced according to this process is also described.

### BACKGROUND OF THE INVENTION

The present invention relates to an improved ruler, in particular to an improved ruler of the type known as a quilting ruler, especially a clear acrylic quilting ruler, which rulers are for use in measuring fabric for quilting and related needlework, scrapbooking and other craft techniques. Rulers of this type have a lower, fabric-contacting, surface and an upper surface through which the scalar markings on the ruler can be viewed.

The present invention further relates to an improved process for the manufacture of rulers of this type and to rulers which have been manufactured using the improved process.

It is known to produce rulers which have a pattern printed onto the lower, fabric-contacting, surface. These patterns are printed onto the ruler after the scalar markings have been printed, using printing compositions which typically comprise an ink, in particular a screen printing ink; an adhesive; a varnish, for example an acrylic varnish and a filler, in particular finely ground sand or pumice, dissolved in a solvent. When used to print an area onto a quilting ruler of the type described above, the printing imparts non-slip characteristics thereto.

It is a disadvantage of the printing compositions known for use in this process, that, after the liquid printing composition has been applied in the desired pattern to an article, the article has to be transferred to a rack and allowed to dry in the air over a period of several hours, typically overnight. In the case of rulers, in particular quilting rulers, it is required that the rulers are additionally printed with one or more sets of scalar markings in different colours using inks without fillers. Where the article is to be printed in this way, each set of coloured markings has to be allowed to dry, again over a period of several hours, which means that the manufacture of these articles takes an uneconomically long period of time. In addition, the printing process has to be carried out as a batch process rather than a continuous process, which is less desirable.

It is a further disadvantage of the known process that, because the printing compositions used in the known process are solvent based, the solvent tends to evaporate from the composition before the composition is applied to the substrate, so that solvent has to be added to the composition to maintain the required viscosity. It is a further disadvantage that because the composition is solvent based, it cannot be left in the screen during breaks in work because of the risk of the ink drying in the image area and damaging the screen. It is a still further disadvantage of solvent based printing compositions that the use of solvents may cause environmental problems.

It is a further disadvantage of rulers printed according to the known process that, after extensive use, the non-slip character of the printed pattern degrades and may be reduced by as much as 75% of its original level due to wear and to scratching. It is observed that while the printed marks are still visible, the filler has worn away or been scratched off.

It is also a disadvantage of rulers printed according to the known process that, in order to provide the non-slip area with sufficient ‘grip’ the fabric-contacting surface of the printed area may be undesirably rough, leading to snagging of the fabric, or may be excessively opaque, at least partially obscuring the fabric and/or the scalar markings on the ruler.

### SUMMARY OF THE INVENTION

It is an object of the present invention to provide an improved ruler and an improved process for its manufacture, in which the above disadvantages are reduced or substantially obviated.

### DETAILED DESCRIPTION OF THE PREFERRED EMBODIMENT

The present invention provides a process for the manufacture of a ruler for use in the accurate measuring of fabric for quilting, patchwork and other crafts, which process includes the steps of forming a ruler blank from a single layer of a substantially transparent material, printing, in one or more discrete stages, a pattern onto a surface of the blank, the pattern comprising a single colour or multi-colour pattern corresponding to the scalar markings on the ruler and in a further stage printing a non-slip pattern onto the same surface of the ruler, characterised in that the printing composition used for printing the non-slip pattern comprises an ink which can be dried using ultra violet light; an adhesive and a granular filler, capable of imparting non-slip properties to the surface of the ruler.

In a preferred embodiment of the process according to the invention, the printing composition further comprises a photo initiator.

Preferred granular fillers include glass beads, ground glass, pumice or ground plastics materials.

The pattern printed onto the ruler to provide the scalar markings is preferably printed using a screen printing process using an ultraviolet printing ink.

The present invention further provides a ruler which has been printed by the process according to the invention.

It has surprisingly been found that rulers produced according to the present invention have increased resistance to wear, the non-slip properties being maintained over extended periods of use.

It has also surprisingly been found that, in rulers produced according to the present invention, the non-slip areas are smoother than those produced by the conventional process, reducing the danger of snagging and are less opaque, improving the visibility in use of the scalar markings and the fabric.

In use, the non-slip areas of rulers produced according to the present invention provide excellent grip characteristics on a wide variety of fabrics, in particular the fabrics generally used in quilting, patchwork, needlework and crafts. The rulers can also be used in paper and card crafts, when the non-slip[characteristics are also useful and effective.

The rulers according to the present invention are used accurately to measure pieces of fabric, in one or more layers, which are then cut to exact size with the ruler in place, generally using a rotary cutter. The pieces of fabric are then joined to other pieces of fabric to make a finished article. It will be appreciated that, for the accurate cutting of the pieces of fabric, which is essential for their future use, any slippage between the ruler and the fabric must be minimised.

The opaque, non-slip areas on the fabric-contacting surface of the transparent ruler allow the user to maintain the ruler in precise contact with the fabric, while at the same time enabling the user to see the ruler markings and the fabric clearly.

It is a further advantage of the process according to the invention, that the time taken to produce a ruler, in particular the drying time, is very much reduced. In conventional printing processes using a solvent based air drying printing compositions, the drying time is typically of the order of eight hours. In contrast to this, when the process according to the invention is used to manufacture a ruler, and the printed ruler is passed through a UV dryer, typically at a temperature not exceeding about 40° C., the ruler is dry within 30 seconds. The dried ruler can then be printed with further colours in the same way if required and can then be packaged ready for shipping.

1. A process for the manufacture of a ruler for use in the accurate measuring of fabric for quilting, patchwork and other crafts, which process includes the steps of forming a ruler blank from a single layer of a substantially transparent material, printing, in one or more discrete stages, a pattern onto a surface of the blank, the pattern comprising a single colour or multi-colour pattern corresponding to the scalar markings on the ruler and in a further stage printing a non-slip pattern onto the same surface of the ruler, characterised in that the printing composition used for printing the non-slip pattern comprises an ink which can be dried using ultra violet light; an adhesive and a granular filler, capable of imparting non-slip properties to the surface of the ruler.

2. A process according to claim 1 wherein the printing composition further comprises a photo initiator.

3. A process according to claim 1 wherein the granular filler comprises glass beads, ground glass, pumice or ground plastics materials.

4. A process according to claim 1 wherein the pattern printed onto the ruler to provide the scalar markings is printed using a screen printing process using an ultraviolet printing ink.

5. A ruler which has been printed by the process according to claim 1.

6. A ruler according to claim 5 which is a clear acrylic quilting ruler.
